(19) United States
(12) Patent Application Publication
(10) Pub. No.: US 2025/0198911 A1
(43) Pub. Date: Jun. 19, 2025

(54) PROCEDURE FOR COMMISSIONING A MEASURING SYSTEM, MEASURING SYSTEM AND DATA STORAGE MEMORY

(71) Applicant: Endress+Hauser Conducta GmbH+Co. KG, Gerlingen (DE)

(72) Inventors: Thilo Krätschmer, Gerlingen (DE); Joachim Bolle, Stockach (DE); Torsten Zeidler, Radebeul (DE)

(21) Appl. No.: 18/980,279

(22) Filed: Dec. 13, 2024

(30) Foreign Application Priority Data
Dec. 14, 2023 (DE) 10 2023 135 220.2

(51) Int. Cl. G01N 21/25; G01N 21/33

(52) U.S. Cl. CPC G01N 21/255; G01N 21/33; G01N 2201/063; G01N 2201/127

(57) ABSTRACT

The present disclosure includes a procedure for commissioning a measuring system for optical extinction measurement for a measured variable, where the measuring system comprises a plurality of optical and electrical components. The procedure includes steps of creating an individual calibration model for the measuring system, comprising the relationship between extinction and measured variable, where the measuring system comprises a light source and the calibration model comprises the emission spectrum of the light source, and where the measuring system comprises a detector and the calibration model comprises the sensitivity spectrum of the detector. The method includes adjusting the measuring system with at least one measuring point using the individual calibration model.

### CROSS-REFERENCE TO RELATED APPLICATION

The present application is related to and claims the priority benefit of German Patent Application No. 10 2023 135 220.2, filed on Dec. 14, 2023, the entire contents of which are incorporated herein by reference.

### TECHNICAL FIELD

The present disclosure relates to a procedure for commissioning a measuring system for optical extinction measurement for a measured variable, a measuring system, and a data storage memory.

### BACKGROUND

In many optical measuring systems, the measured variable (e.g., concentration) of an analyte is determined depending upon the measured extinction. In general, in optics, the extinction (also called optical density) is a measure of the attenuation of radiation (e.g., light) after passing through a medium. It depends upon the wavelength λ. With I₀ as incident radiation and/as emitted radiation, the extinction E, as a logarithmic value, describes the reciprocal of the transmittance τ with

$${E}_{λ} = {log}_{10} \frac{{I}_{0}}{I} = - {log}_{10} {τ}_{λ} .$$

In general, the processes involved in the attenuation are absorption, scattering, diffraction, and reflection. In analytical applications, however (see below), scattering and diffraction are often insignificant. In the following, and without restricting generality, the problem is described with reference to absorption.

With a sensor for measuring, for example, the nitrate concentration, the absorption is determined at two wavelengths in a liquid, and the concentration of the parameter nitrate in mg/L is calculated using a calibration curve.

In extinction sensors, the sought parameter concentration c is generally calculated using the Lambert-Beer equation with

$${E}_{λ} = {log}_{10} \frac{{I}_{0}}{I} = {ε}_{λ} \cdot c \cdot d ,$$

with d as the optical path length or gap, and & as the extinction coefficient of the wavelength. While the path length is usually easy to determine, the extinction coefficient is usually determined by a calibration in a reference solution of known concentration.

In this case, calibration is usually understood as the detection of a deviation between the measured value measured by the sensor and the actual, correct measured value.

In real measurements, the linear relationship between extinction and concentration specified by Lambert-Beer usually kinks starting at a certain extinction. This kinking can have various reasons: scattered light in the optical system, non-linear effects of the medium, particles in the medium which lead to additional scattering, etc. This is shown in FIG. 1a.

If only a linear mapping between measured extinction and concentration of the measuring parameter is taken into account, the measuring range is greatly reduced in the case of a kinking calibration curve. Therefore, attempts are often made to reproduce the nonlinearity of the calibration curve in the association in the measuring system between “measured extinction” and “concentration of the analyte to be measured.”

Polynomials or other closed curves and also piecewise defined mappings (“look-up tables”) are usually used to represent the nonlinearity of the calibration curve as well as possible. In order to parameterize these curves or images, the absorption of different standard liquids (i.e., with different defined concentrations) is usually measured in analytical devices after production and commissioning.

This is called an alignment or adjustment. Adjustment refers to the setting or adjusting of the sensor, so as to eliminate systematic variances to the extent necessary for the intended application.

DE 10 2019 121 304 A1 describes a procedure with which the above-described simulation of the nonlinearity of the calibration curve is carried out for each “pixel” of a spectrometer in order to improve the measuring range or the dynamics of the spectrometer in this case as well. In this document, the simulation of the nonlinearity is also based upon a certain number of adjustment points with substances of known absorption spectra, in this case, for example, with solid-state standards.

It is assumed that the nonlinearity between the recorded adjustment points (e.g., three adjustment points) is known and, above all, invariable.

However, this assumption can lead to larger accuracy deviations if there are undetected influences on the shape of the calibration curve. For example, if a broadband light source is used, and this is limited to a specific wavelength by one or more filters, the filter behavior is therefore not perfect. The filter also lets some unwanted light through.

Imperfect filter behavior, e.g., in a nitrate probe, leads to wavelengths at which nitrate is not absorbed but which still pass through the filter in an attenuated form and reach the detector. This undesirable signal is independent of the actual nitrate concentration in the medium and leads to the kinking behavior of the calibration curve mentioned above. As explained above, this nonlinear behavior can be compensated for by a suitably chosen shape of the calibration curve. The problem, however, is that the filter behavior is not “constantly wrong,” but changes from piece to piece or batch to batch due to different production conditions. For example, a calibration curve may fit perfectly for a first batch, but may lead to large deviations for a second batch. FIG. 1b shows the absorption against the concentration for different batches.

If one assumes a constant calibration curve shape and uses the calibration curve of the first batch, and adjusts it as mentioned above with a filter of the second batch at, for example, three points, the measurement accuracy results shown in FIG. 1c.

It can be seen that the measurement accuracy is logically very good at the three adjustment points, but the differently kinking calibration curve, which originates from the different filter transmission spectra, results in deviations from the target concentration between the adjustment points. These deviations can be so large that they exceed the specifications of the measuring system.

### SUMMARY

The present disclosure is based upon the object of compensating for piece or batch tolerances of the various individual components of an extinction sensor.

The object is achieved by a procedure for commissioning a measuring system for optical extinction measurement for a measured variable, wherein the measuring system comprises a plurality of optical and electrical components, the procedure comprising the steps of creating an individual calibration model for the measuring system, comprising the relationship between extinction and measured variable, wherein the measuring system comprises a light source and the calibration model comprises the emission spectrum of the light source, and wherein the measuring system comprises a detector and the calibration model comprises the sensitivity spectrum of the detector; and adjusting the measuring system with at least one, preferably three, measuring points by means of the individual calibration model.

The present disclosure thus makes it possible to minimize the dependence of extinction sensors upon different transmission curves of the components of the measurement setup in the non-linear assignment of “measured extinction” to “measured variable of the analyte to be determined.” This includes, on the one hand, all components through which the light passes from the light source to the detector (inclusive, in each case) and, on the other, the electronic properties from the detection of the detector signal to the digital raw signal of the measured value of the absorption. Although a constant, non-linear calibration curve can compensate for these effects, piece or batch influences of the components are not taken into account in a constant, non-linear calibration curve, which leads to measurement inaccuracies.

The present document enables the calculation and implementation of a sensor-specific calibration curve, i.e., an individual calibration curve, based upon the properties of the actually installed components in order to compensate for the influence of piece or batch tolerances of installed components, thus improving the measurement accuracy of the measuring system.

One embodiment provides that the individual calibration model comprise a transmission spectrum of at least one further optical or electrical component.

One embodiment provides that the measuring system comprise a filter as an optical component, and the calibration model comprise a transmission spectrum of the optical filter.

One embodiment provides that the measuring system comprise a window and/or a lens as an optical component, and the calibration model comprise the transmission spectrum of the window and/or the lens.

One embodiment provides that the measuring system comprise a data processing unit, an analog-digital converter, or the like as an electrical component, and the calibration model comprise the dynamics of the signal chain, the bit resolution of the analog-digital converter, the signal-to-noise ratio, and/or the noise.

One embodiment provides that the individual calibration model be calculated by convolution.

One embodiment provides that, after an optical or electrical component is replaced, the individualized calibration model be updated based upon the changed component.

The object is further achieved by a measuring system for optical extinction measurement comprising a light source, a detector; wherein the measuring system is designed to determine a measured variable via an individual calibration model, wherein the calibration model has been created according to a step of the method disclosed herein.

One embodiment provides that the measuring system comprise a further optical or electrical component.

The object is further achieved by a data storage memory, on which an individual calibration model is stored, which was created according to a step of the method disclosed herein.

### BRIEF DESCRIPTION OF THE DRAWINGS

This is explained in more detail with reference to the following figures.

FIG. 1a shows the linear relationship between extinction and concentration.

FIG. 1b shows the absorption against the concentration for different batches.

FIG. 1c shows measurement accuracy results.

FIG. 2 shows the claimed measuring system.

FIG. 3 shows a symbolic representation of the claimed measuring system.

FIG. 4 shows components of the measuring system and their influencing factors.

FIG. 5 shows sensor-specific calibration curves for different filters.

FIG. 6 shows a claimed data storage memory.

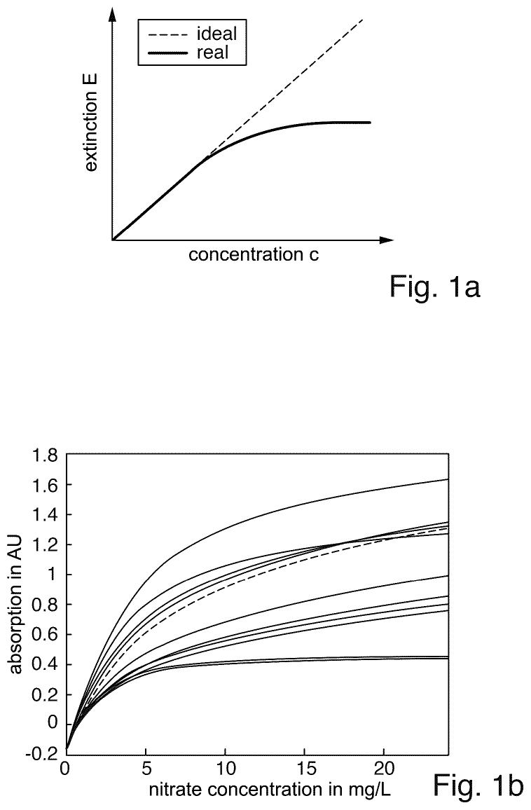

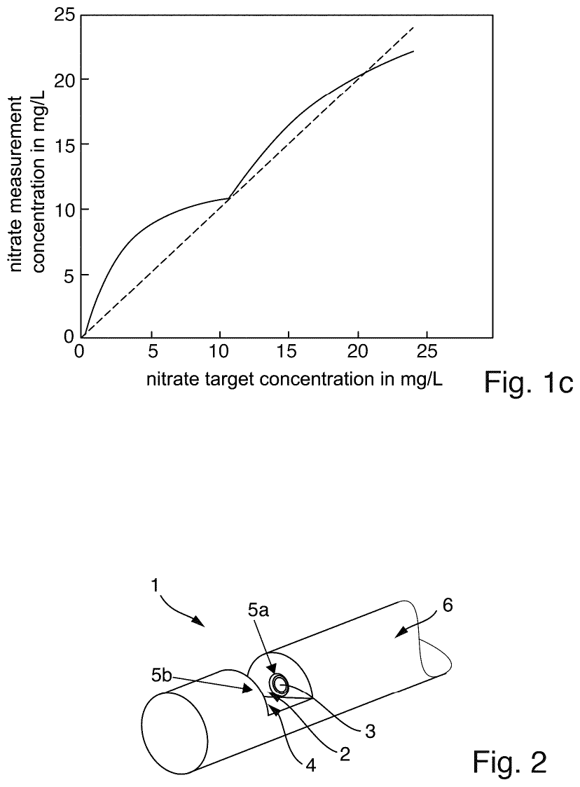

In the figures, the same features are labeled with the same reference signs.

### DETAILED DESCRIPTION

The claimed measuring system in its entirety has reference sign 1 and is shown in FIG. 2. The measuring system is a sensor for optical extinction measurement—for example, a nitrate or SAC sensor.

“SAC” means the spectral absorption coefficient. In this context, an “SAC sensor” is understood to mean a sensor that determines the spectral absorption coefficient by means of the absorption of measuring radiation by certain substances in a medium. In particular, the total organic carbon (TOC) contributing to the SAC value and the chemical oxygen demand (COD) are determined thereby. The TOC or COD value can be deduced from the SAC value.

For SAC and nitrate sensors, the measured value is usually determined via an absorption measurement at a measuring and a reference wavelength. These wavelengths are in the UV and UV-VIS range. A possible measurement and reference wavelength combination for nitrate is 214 nm and 254 nm, and for SAC, 254 nm and 550 nm. However, other combinations are conceivable.

The measuring principle will be briefly explained with reference to a nitrate sensor. The measuring system 1 comprises a housing 6 with a portion immersed in the medium to be measured having a gap 2 (the cuvette gap or optical path length) into which the medium can penetrate. The gap 2 is passed through by a measuring beam (with a measuring wavelength) and a reference beam (with a reference wavelength). Nitrate ions contained in the medium, and thus in the gap, absorb the light in the range of the measuring wavelength of 214 nm proportionally to their concentration, while the UV light in the reference channel at 254 nm remains almost unchanged. The relation between the reference and measuring channel is used as the measurement result. This relation is converted into the nitrate concentration using the stored calibration curve.

The calibration curve is recorded in advance using suitable calibration means. Certain standard liquids are often used; solutions of sodium nitrate, for example, are used as typical calibration means for nitrate sensors. For example, potassium hydrogen phthalate (KHP) is used in SAC value measurements.

The light from a light source 3 shines through the gap 2. For example, a pulsed flash lamp or a plurality of LED's are used as the light source 3. The flash lamp emits a spectrum that contains at least light of a measurement wavelength and a reference wavelength. The LED's are designed to emit light of the corresponding measurement wavelength and reference wavelength. For example, in the case of nitrate, 214 nm and 254 nm and in the case of SAC, 254 nm and 550 nm, can be selected for the wavelengths. If the light source 3 is a broadband light source, one or more filters 5a are used so that only corresponding wavelengths are allowed through.

On the opposite side, there is a detector 4. The detector 4 is, for example, one or more photodiodes. The detector 4 can comprise a beam splitter (not shown) which directs the light emitted by the light source 3 to a detector for receiving light of the measurement wavelength and to a detector for receiving light of the reference wavelength. A filter 5b is mounted in front of each of the two detectors, which allows only light of the measuring wavelength to pass through the measuring receiver, and allows only light of the reference wavelength to pass through the reference receiver.

To protect the detector 4 or light source 3 and the gap 2 (i.e., medium), a window 7 is provided therebetween in each case, which is transparent for the measuring and reference wavelength. Depending upon requirements, additional optical devices such as lenses, etc., are arranged for better beam guidance.

In the gap 2, the substances to be measured, such as the nitrate ions, absorb the light in the range of the measuring wavelength (214 nm) proportionally to their concentration, while the light in the reference channel (254 nm) remains almost unchanged. The measuring principle is based upon the Lambert-Beer law (see above) with the dependence between the absorption of light and the concentration of the absorbing substance.

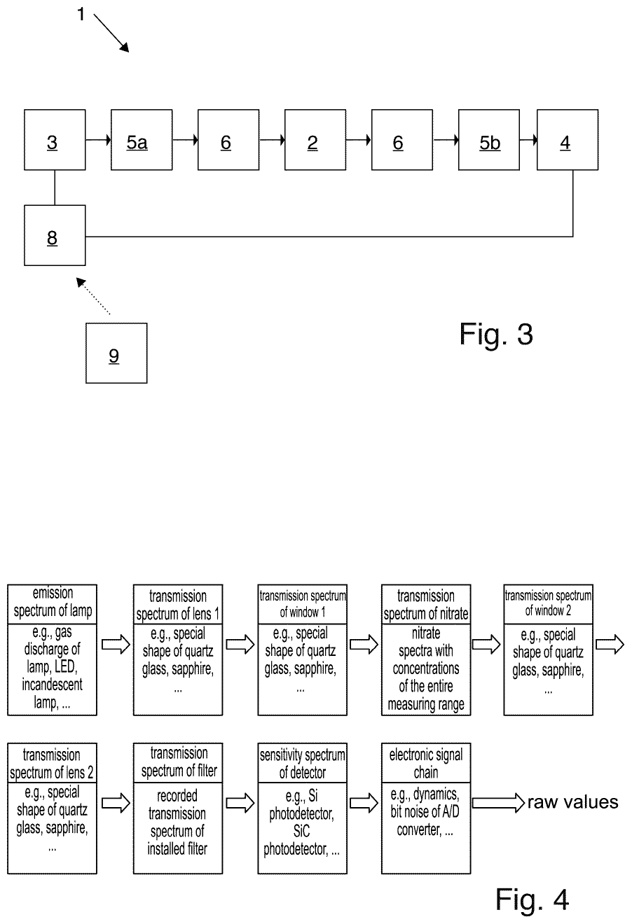

FIG. 3 shows a symbolic illustration of the claimed measuring system 1, which shows the individual components of the measuring system 1.

The measuring system therefore comprises at least one light source 3. This includes, for example, a filter 5a for filtering the correct wavelength. The light then passes through a window 6 into the gap 2 (i.e., into the medium) and again reaches, through a window 6, another filter 5b, to the detector 4. A data processing unit 8 is connected to the light source 2 and the detector 4, and is designed, for example, to switch the light source 3 on and off or to carry out the data processing. The data processing unit 8 determines a measured variable (e.g., the nitrate concentration) via an individual calibration model which is explained in more detail in the next sections. If necessary, the measuring system 1 also comprises one or more lenses or other components for better beam guidance.

The measuring system 1 comprises one or more optical and electrical components, some of which have already been mentioned above. Optical components are, for example, the light source 3, the detector 4, filters 5a, b, window 8, or lenses. An electrical component is the data processing unit 8.

For each sensor, a separate sensor-specific calibration curve is created with which the measuring system calculates the desired measured variable of the analyte (e.g., nitrate concentration) for a measured extinction. In this case, the sensor-specific calibration curve takes into account all the components that have a significant influence on the curve shape of the calibration curve. In this case, this influence can include both optical transmission properties of the components as well as, for example, electronic properties of the components (bit resolution of the A/D converter, dynamics of the signal chain, etc.).

For the above example of a nitrate sensor, this can be sketched for one measuring channel (here, one measuring wavelength, e.g., 214 nm) as shown in FIG. 4.

If all the influences of the installed components of a sensor 1 are known, as shown in FIG. 4, a sensor-specific calibration curve can be determined by calculating the individual measuring channels by convolving the emission spectrum of the light source 1 with all subsequent transmission spectra and taking into account the properties of the electronic signal chain. At least in this step, the emission spectrum of the light source 3, the sensitivity spectrum of the detector 4, and the relationship between extinction and the measured variable (i.e., the transmission spectrum of the measured variable) are used. This mathematical algorithm can now be performed for different nitrate concentrations distributed over the desired measuring range, thereby creating a sensor-specific relationship between “measured absorption” and “nitrate concentration to be measured.”

For example, the measuring system 1 comprises a filter 5a, b as an optical component. The specific calibration model then comprises a transmission spectrum of this optical filter 5a, b.

For example, the measuring system 1 comprises a window 7 and/or a lens as an optical component. Then, the specific calibration model includes a transmission spectrum of this/these window(s) 7 and/or the lens.

For example, the measuring system 1 comprises a light source 3 as an optical component. Then the specific calibration model includes the emission spectrum of this light source 3.

For example, the measuring system 1 comprises a detector 4 as an optical component. Then the specific calibration model covers the sensitivity spectrum of this detector 4.

For example, the measuring system 1 comprises a data processing unit 8, an analog-digital converter, or the like as an electrical component. The specific calibration model then comprises the dynamics of the signal chain, the bit resolution of the analog-digital converter, the signal-to-noise ratio, and/or the noise.

Preferably, the calibration model comprises a plurality of influencing factors such as the transmission spectrum of an optical component (see above) and another transmission spectrum, emission spectrum, sensitivity spectrum, or a portion from an electrical component. An example of this is the emission spectrum of the light source 3, a sensitivity spectrum of the detector 4, a transmission spectrum of the measured variable, and a transmission spectrum of the window 5a or windows 5a, b.

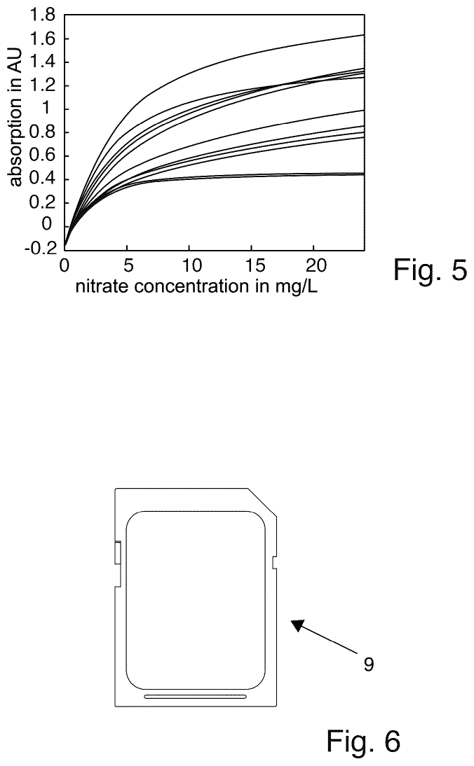

FIG. 5 shows various sensor-specific calibration curves for a measuring system 1, which were recorded with different filters 5a, b and thus different transmission spectra of the respective filters 5a, b. It can be seen that the calibration curve depends strongly upon the properties of the filter. The respective calibration curve is selected according to the filter.

Since, for reasons of time and cost, the influences of all components actually installed are not usually measured, and manufacturing tolerances also have an influence on the calibration curve, an adjustment is carried out at, for example, three standard concentrations. Since the most influential components have been taken into account individually during the sensor-specific calibration (in the example above, the transmission spectrum of the actually installed filter), the measurement accuracy between the adjustment points is now significantly improved.

The calculated sensor-specific calibration can be calculated with arbitrarily fine-grained concentration steps, which facilitates conversion into an implementable closed, piecewise defined, or otherwise designed form.

A further advantage of this methodology is that the measurement inaccuracies of an implementation of the calibration curve can now be determined for each sensor. For example, if one were confronted with a choice in the prior art of implementing the calibration curve either as a 5th order polynomial or as a 7th order polynomial, a complex series of measurements would have to be carried out in order to evaluate the difference in measurement accuracy. Using the sensor-specific calibration curve, the difference between the two implementations can be calculated without further measurement. This therefore serves as a very efficient evaluation of which implementation represents the optimal implementation for the system.

If all the properties of the installed components are saved during production, critical components can be replaced even after the manufacture of the sensor—for example, during a service call. For this purpose, the sensor-specific calibration curve can be calculated using the properties of the replacement component, and sent with the replacement part, e.g., on a storage medium, and loaded onto the measuring system during the service call.

FIG. 6 shows a data storage memory 9 such as an SD card on which an individual calibration model as described above is stored. The data storage memory 9 can be connected or plugged into the data processing unit 8 (see the dashed arrow in FIG. 3) in order to transfer an updated individual calibration model to the data processing unit 8 and thus to the measuring system 1. This may be necessary, for example, if a component has been replaced, such as the light source 3 or a filter 5a, b.

1. A procedure for commissioning a measuring system for optical extinction measurement for a measured variable,
wherein the measuring system comprises a plurality of optical and electrical components, the procedure comprising the steps of:
creating an individual calibration model for the measuring system, comprising the relationship between extinction and measured variable,
wherein the measuring system comprises a light source, and the calibration model comprises the emission spectrum of the light source, and
wherein the measuring system comprises a detector, and the calibration model comprises the sensitivity spectrum of the detector; and
adjusting the measuring system with at least one measuring point using the individual calibration model.

2. The procedure according to claim 1,
wherein the individual calibration model includes a transmission spectrum of at least one further optical or electrical component.

3. The procedure according to claim 2,
wherein the measuring system includes a filter as an optical component, and the calibration model includes a transmission spectrum of the optical filter.

4. The procedure according to claim 2,
wherein the measuring system includes a window and/or a lens as an optical component, and the calibration model includes the transmission spectrum of the window and/or the lens.

5. The procedure according to claim 2,
wherein the measuring system includes a data processing unit, an analog-digital converter, or the like as an electrical component, and the calibration model includes the dynamics of the signal chain, the bit resolution of the analog-digital converter, the signal-to-noise ratio, and/or the noise.

6. The procedure according to claim 1,
wherein the individual calibration model is calculated by convolution.

7. The procedure according to claim 1,
wherein, after an exchange of an optical or electrical component, the individualized calibration model is updated based upon the changed component.

8. A measuring system for optical extinction measurement, comprising
a light source,
a detector;
wherein the measuring system is designed to determine a measured variable via an individual calibration model, wherein the calibration model was created according to the following steps:
creating an individual calibration model for the measuring system, comprising the relationship between extinction and measured variable,
wherein the measuring system comprises a light source, and the calibration model comprises the emission spectrum of the light source, and
wherein the measuring system comprises a detector, and the calibration model comprises the sensitivity spectrum of the detector; and
adjusting the measuring system with at least one measuring point using the individual calibration model.

9. The measuring system according to claim 1, comprising another optical or electrical component.

10. A data storage memory,
on which an individual calibration model is stored, which was created according to the following steps:
creating an individual calibration model for the measuring system, comprising the relationship between extinction and measured variable,
wherein the measuring system comprises a light source, and the calibration model comprises the emission spectrum of the light source, and
wherein the measuring system comprises a detector, and the calibration model comprises the sensitivity spectrum of the detector; and
adjusting the measuring system with at least one measuring point using the individual calibration model.
